(19) United States
(12) Patent Application Publication
(10) Pub. No.: US 2015/0326850 A1
(43) Pub. Date: Nov. 12, 2015

(54) THREE-DIMENSIONAL LIQUID CRYSTAL DISPLAY DEVICE AND DRIVING METHOD THEREOF

(71) Applicant: BOE TECHNOLOGY GROUP CO., LTD., Beijing (CN)

(72) Inventors: Ki Man KIM, Beijing (CN); Jaegeon YOU, Beijing (CN)

(73) Assignee: BOE TECHNOLOGY GROUP CO., LTD., Beijing (CN)

(21) Appl. No.: 14/380,566

(22) PCT Filed: Dec. 17, 2013
(86) PCT No.: PCT/CN2013/089732

§ 371 Date: Aug. 22, 2014

(30) Foreign Application Priority Data
Mar. 29, 2013 (CN) 201310109330.X

(51) Int. Cl. H04N 13/04; G02B 27/22; G02F 1/1362; G02B 27/26; G02F 1/1335

(52) U.S. Cl. CPC H04N 13/0454; G02B 27/26; G02F 1/133528; G02F 1/136286; G02B 27/2214

(57) ABSTRACT

A three-dimensional (3D) liquid crystal display (LCD) device is provided, comprises: an LCD panel (10), configured to display an image and comprising a plurality of first pixel units; a liquid crystal light-splitting device (100), disposed on a light exiting side of the LCD panel (10) and comprising a plurality of second pixel units; and a first polarizer (200), disposed on a light exiting side of the liquid crystal light-splitting device (100), wherein the second pixel units are in one-to-one correspondence with the first pixel units; in a condition that the 3D LCD device is in a 3D operating mode, the liquid crystal light-splitting device (100) has a light-splitting function; and in a condition that the 3D LCD device is in a 2D operating mode, an operating state of each of the plurality of second pixel units of the liquid crystal light-splitting device (100) is consistent with that of a corresponding first pixel unit.

### TECHNICAL FIELD

The embodiment of the present invention relates to a three-dimensional (3D) liquid crystal display (LCD) device and a driving method thereof.

### BACKGROUND

At present, 3D display has become one of the development trends in the display field. The fundamental principle of the 3D display is to form stereoscopic vision based on binocular stereoscopic parallax, namely a left eye of a viewer sees a left-eye image and a right eye of the viewer sees a right-eye image, wherein the left-eye image and the right-eye image are a pair of stereoscopic images with the parallax.

A 3D display device utilizes the binocular parallax. At the same moment, the left eye can see only the left-eye image and the right eye can see only the right-eye image, namely the left eye and the right eye see different images respectively. The two images are conveyed to the brain through the retina and merged by the brain, and hence the depth sense and the actual sense (namely stereoscopic perception) of a 3D image can be produced.

In the prior art, a switching of a 2D displaying and a 3D displaying can be easily achieved by means of electrical control using a liquid crystal light-splitting 3D display device comprising a liquid crystal lens or a liquid crystal grating. In addition, the liquid crystal light-splitting 3D display device also has a plurality of advantages such as simple structure, easily manufacturing and adjustable driving. The liquid crystal light-splitting 3D display device has become one of major development trends in the future.

However, a current LCD device is to display an image by optical rotation of a liquid crystal layer. As illustrated in FIG. 1, the current LCD panel comprises: a lower substrate 14, an upper substrate 12 arranged opposite the lower substrate 14, and a liquid crystal layer 13 disposed between the lower substrate 14 and the upper substrate 12. In order to change scattered light emitted from a backlight assembly into polarized light (as shown by arrows in FIG. 1), a lower polarizer 15 is disposed on a light incident side of the lower substrate 14 of the LCD device, and an upper polarizer 11 is disposed on a light exiting side of the upper substrate 12, so as to achieve the image display. In a case of completely dark display of a two-dimensional (2D) image, light cannot be completely shielded, and hence the phenomenon of light leakage will occur. For example, leaking light is shown by the reference numeral 16 in the figure. Therefore, the contrast may be reduced and completely dark state cannot be achieved in the case of dark display.

### SUMMARY

Embodiments of the present invention provide a 3D LCD device and a driving method of the 3D LCD device, which can be operated under 2D and 3D display modes, has an improved contrast in the case of the 2D display mode and can achieve a completely dark display of a 2D image.

An embodiment of the present invention provides a 3D LCD device, which comprises: an LCD panel, configured to display an image and comprising a plurality of first pixel units; a liquid crystal light-splitting device, disposed on a light exiting side of the LCD panel and comprising a plurality of second pixel units; and a first polarizer, disposed on a light exiting side of the liquid crystal light-splitting device, wherein in a condition that the 3D LCD device is in a 3D operating mode, the liquid crystal light-splitting device has a light-splitting function; and in a condition that the 3D LCD device is in a 2D operating mode, an operating state of each of the plurality of second pixel units of the liquid crystal light-splitting device is consistent with that of a corresponding first pixel unit, and the second pixel units are in one-to-one correspondence with the first pixel units.

An embodiment of the present invention provides a driving method of the 3D LCD device as mentioned above, comprising: in a condition that the 3D LCD device is in a 3D operating mode, the liquid crystal light-splitting device is formed into a liquid crystal lens or a liquid crystal grating; and in a condition that the 3D LCD device is in a 2D operating mode, the first electrode and the second electrode of each of the second pixel units of the liquid crystal light-splitting device are applied with voltage or not applied with voltage, so that liquid crystal molecules in the second liquid crystal layer of each second pixel unit and liquid crystal molecules in the first liquid crystal layer of corresponding first pixel unit have same inclination angle.

### BRIEF DESCRIPTION OF THE DRAWINGS

In order to clearly illustrate the technical solution of the embodiments of the invention, the drawings of the embodiments will be briefly described in the following; it is obvious that the described drawings are only related to some embodiments of the invention and thus are not limitative of the invention.

FIG. 1 is a schematic cross-sectional view of a current LCD panel;

FIG. 2 is a simple structural cross-sectional view of a 3D LCD device provided by an embodiment of the present invention;

FIG. 3 is a structural view of an example of a 3D LCD device provided by an embodiment of the present invention; and

FIG. 4 is a structural view of another example of a 3D LCD device provided by an embodiment of the present invention.

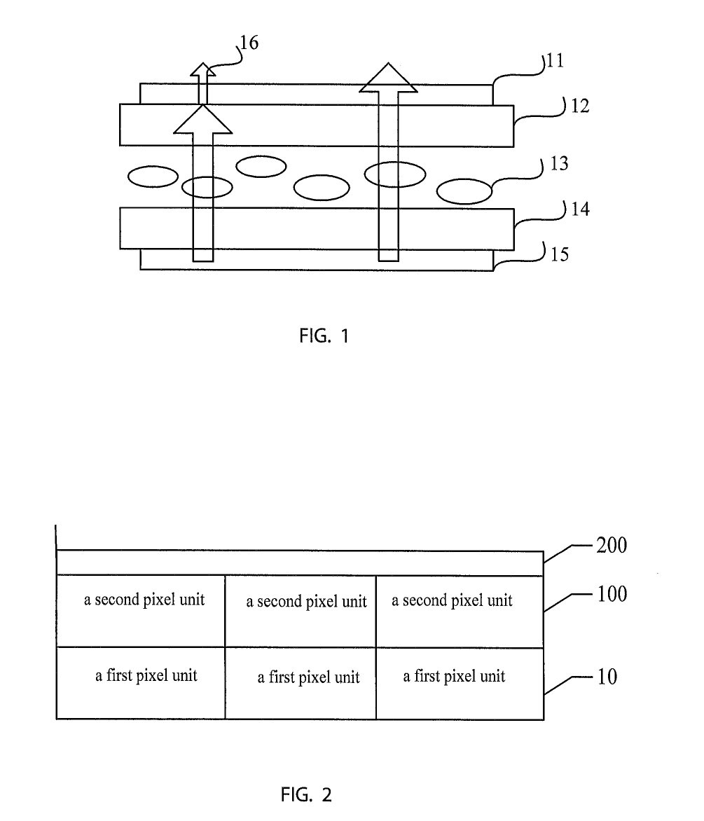

### DETAILED DESCRIPTION

In order to make objects, technical details and advantages of the embodiments of the invention apparent, the technical solutions of the embodiment will be described in a clearly and fully understandable way in connection with the drawings related to the embodiments of the invention. It is obvious that the described embodiments are just a part but not all of the embodiments of the invention. Based on the described embodiments herein, those skilled in the art can obtain other embodiment(s), without any inventive work, which should be within the scope of the invention.

Detailed description will be given to the three-dimensional (3D) liquid crystal display (LCD) device provided by embodiments of the present invention with reference to the accompanying drawings.

### A First Embodiment

FIG. 2 is a simple cross-sectional view of a 3D LCD device provided by an embodiment of the present invention. As illustrated in FIG. 2, the 3D LCD device provided by the embodiment of the present invention comprises: a liquid crystal display (LCD) panel 10, configured to display an image and comprising a plurality of first pixel units; a liquid crystal light-splitting device 100, disposed on a light exiting side of the LCD panel 10 and comprising a plurality of second pixel units; and a first polarizer 200, disposed on a light exiting side of the liquid crystal light-splitting device, wherein the second pixel units are in one-to-one correspondence with the first pixel units, and in a condition that the 3D LCD device is in a 3D operating mode, the liquid crystal light-splitting device has a function of light splitting; and in a condition that the 3D LCD device is in a 2D operating mode, an operating state of each second pixel unit of the liquid crystal light-splitting device is consistent with that of the corresponding first pixel unit.

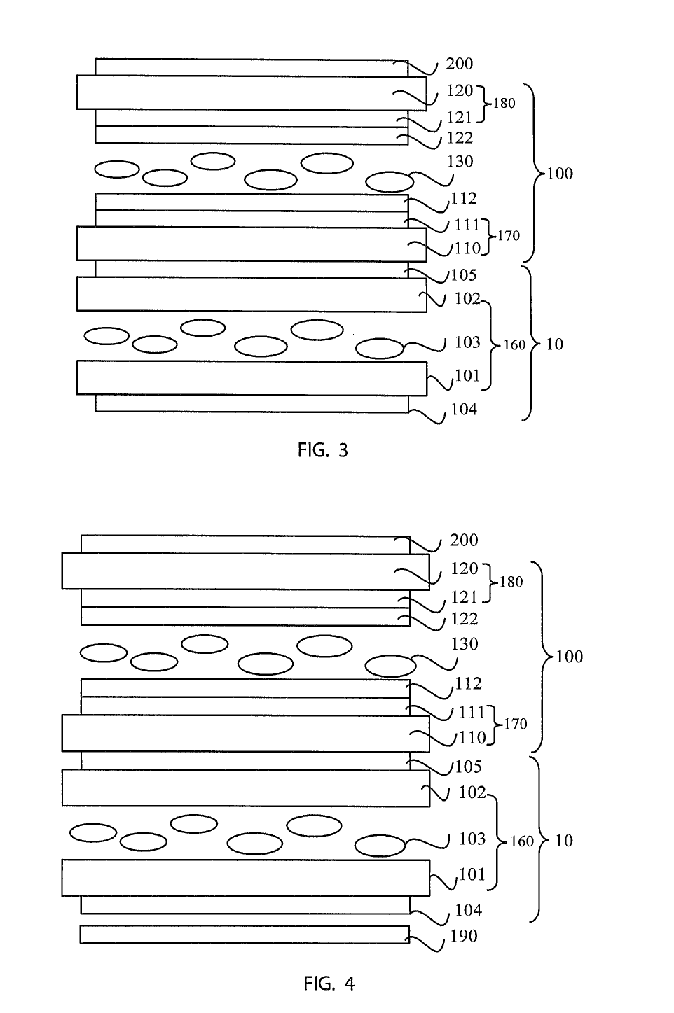

Moreover, FIG. 3 is a structural cross-sectional view of an example of the 3D LCD device provided by the embodiment of the present invention. As illustrated in FIG. 3, the LCD panel 10 provided by the embodiment of the present invention comprises: a liquid crystal cell 160, comprising an array substrate 101, a color filter substrate 102 cell-assembled with the array substrate 101; a first liquid crystal layer 103, interposed between the array substrate and the color filter substrate; an upper polarizer 105, disposed on a light exiting side of the liquid crystal cell; and a lower polarizer 104, disposed on a light incident side of the liquid crystal cell. The liquid crystal light-splitting device 100 provided by the embodiment of the present invention comprises: a first substrate 170, with the same structure as that of the array substrate 101; a second substrate 180, cell-assembled with the first substrate; and a second liquid crystal layer 130, disposed between the first substrate and the second substrate.

Exemplarily, as illustrated in FIG. 3, the first substrate provided by the embodiment of the present invention has the following illustrative structure, wherein the first substrate comprises a plurality of second data lines and a plurality of gate lines (not shown in the FIG for simplification), intercrossed with each other; each second pixel unit is defined by the plurality of second data lines and the plurality of second gate lines intercrossed with each other; and in each second pixel unit, the first substrate comprises: a base substrate 110; a thin-film transistor (TFT) (not shown in the figure), formed on the base substrate; and a first electrode 111, formed on one side of the base substrate facing the second liquid crystal layer 130 and electrically connected with a source/drain electrode of the TFT.

Exemplarily, the first substrate provided by the embodiment of the present invention may also have the following, structure, wherein the first substrate comprises a plurality of second data lines and a plurality of second gate lines (not shown in the figure for simplification), intercrossed with each other; each second pixel unit is defined by the plurality of second data lines and the plurality of gate lines intercrossed with each other; and in each second pixel unit, the first substrate comprises: a base substrate; a TFT, formed on the base substrate; a plurality of strip-shaped first electrodes, formed in parallel on one side of the base substrate facing the second liquid crystal layer and electrically connected with a source/drain electrode of the TFT; and a plurality of strip-shaped second electrodes, arranged in the same layer with the first electrodes, the second electrodes and the first electrodes are alternately disposed and parallel to each other. Correspondingly, the array substrate of the LCD panel also has the same structure. When the LCD panel is in a 2D display mode, different voltages are applied to a plurality of strip-shaped first electrodes and a plurality of strip-shaped second electrodes, so that voltage difference can be formed between the first electrodes and the second electrodes to drive liquid crystal molecules to rotate.

Exemplarily, the first substrate provided by the embodiment of the present invention may also have the following structure, wherein the first substrate comprises a plurality of second data lines and a plurality of second gate lines (not shown in the figure for simplification) intercrossed with each other; each second pixel unit is defined by the plurality of second data lines and the plurality of second gate lines intercrossed with each other; and in each second pixel unit, the first substrate comprises: a base substrate; a TFT, formed on the base substrate; a plurality of strip-shaped first electrodes, formed in parallel on one side of the base substrate facing the second liquid crystal layer and electrically connected with a source/drain electrode of the TFT; and a plane-shaped second electrode, separated from the plurality of strip-shaped first electrodes by an insulating layer and more close to the base substrate. Correspondingly, the array substrate of the LCD panel also has the same structure. When the LCD panel is in the 2D display mode, different voltages are applied to the plurality of strip-shaped first electrodes and a plane-shaped second electrode, so that voltage difference can be formed between the first electrodes and the second electrode to drive liquid crystal molecules to rotate.

Exemplarily, the first substrate provided by the embodiment of the present invention may also have the following structure, wherein the first substrate comprises a plurality of second data lines and a plurality of second gate lines (not shown in the figure for simplification) intercrossed with each other; each second pixel unit is defined by the plurality of second data lines and the plurality of second gate lines intercrossed with each other; and in each second pixel unit, the first substrate comprises: a base substrate; a TFT, formed on the base substrate; a plurality of strip-shaped first electrodes, formed in parallel on one side of the base substrate facing the second liquid crystal layer and electrically connected with a source/drain electrode of the TFT; and a plurality of strip-shaped second electrodes, separated from a layer where the plurality of strip-shaped first electrodes are disposed by an insulating layer, in which each second electrode is disposed between every two adjacent first electrodes and more close to the base substrate. Correspondingly, the array substrate of the LCD panel also has the same structure. When the LCD panel is in the 2D display mode, different voltages are applied to the plurality of strip-shaped first electrodes and the plurality of strip-shaped second electrodes, so that voltage difference can be formed between the first electrodes and the second electrodes to drive liquid crystal molecules to rotate.

It should be noted that the operating state being consistent described herein means that: when the 3D LCD device is in the 2D operating mode, the TFT in each second pixel unit of the liquid crystal light-splitting device 100 and a transistor in corresponding first pixel unit are in the same switched-on state or the same switched-off state; and when the TFT is in the switched-on state, same electric field is applied to liquid crystal molecules in the LCD panel 10 and the liquid crystal light-splitting device 100, so that the liquid crystal molecules in them have the same inclination angle.

Moreover, the first substrate and the array substrate of the LCD panel having the same structure in an embodiment of the present invention means that: members in the first substrate and the array substrate are completely the same, have completely same arrangement, and are made of completely same materials and the like.

Exemplarily, as illustrated in FIG. 3, the second substrate 180 of the liquid crystal light-splitting device provided by the embodiment of the present invention comprises: a base substrate 120 and a second electrode 121 formed on one side of the base substrate facing the second liquid crystal layer.

Exemplarily, as illustrated in FIG. 3, the liquid crystal light-splitting device provided by the embodiment of the present invention further comprises a first alignment film 112 formed on one side of the first electrode 111 close to the second liquid crystal layer, and a second alignment film 122 formed on one side of the second electrode close to the second liquid crystal layer. The first alignment film 112 and the second alignment film 122 may be made of polyimide (PI) materials.

Moreover, the first electrodes and the second electrodes of the liquid crystal light-splitting device provided by the embodiment of the present invention may be made of transparent conductive materials such as indium tin oxide (ITO).

Moreover, as illustrated in FIG. 4, the 3D LCD device provided by the embodiment of the present invention further comprises: a backlight 190, disposed on a light incident side of the LCD panel 10.

In addition, it should be noted that a structure of the second substrate of the liquid crystal light-splitting device may be the same with or different from that of the color filter substrate. As for the second substrate, color filters and black matrix may be not arranged in the liquid crystal light-splitting device. Of course, the color filters and the black matrixes may be also disposed.

Moreover, transmission axis directions of the upper polarizer and the lower polarizer in the 3D LCD device provided by the embodiment of the present invention may be parallel with or perpendicular to each other. When the transmission axis directions of the upper polarizer and the lower polarizer are parallel with each other, a transmission axis direction of the first polarizer is parallel to the transmission axis direction of the upper polarizer. When the transmission axis directions of the upper polarizer and the lower polarizer are perpendicular to each other, the transmission axis direction of the first polarizer is perpendicular to the transmission axis direction of the upper polarizer.

Description will be given below to an operating process of the 3D LCD device when the transmission axis directions of the upper polarizer and the lower polarizer are parallel with or perpendicular to each other.

When the transmission axis directions of the upper polarizer and the lower polarizer are parallel with each other, the transmission axis directions of the first polarizer and the upper polarizer are also parallel with each other. When the LCD panel is in a dark state, light passing through liquid crystal molecules of the LCD panel is rotated by an angle, e.g., 90 degree, in the case that a part of the light is leaked, e.g., in the case that the light with a polarization direction of 0 degree is leaked, the light running through the liquid crystal layer of the liquid crystal light-splitting device is also rotated by the same angle, e.g., 90 degrees, thus, the light is shielded by the first polarizer, and hence a completely dark state can be achieved. When the LCD panel is in a bright state, light running through the liquid crystal molecules of the LCD panel is not rotated; the light is not rotated when running through the liquid crystal layer of the liquid crystal light-splitting device; the light completely passes through the first polarizer; hence, a bright display can be achieved.

When the transmission axis directions of the upper polarizer and the lower polarizer are perpendicular to each other, the transmission axis directions of the first polarizer and the upper polarizer are also perpendicular to each other. When the LCD panel is in a dark state, light running through the liquid crystal molecules of the LCD panel is not rotated; in the case that a part of the light is leaked, the light is not rotated when running through the liquid crystal layer of the liquid crystal light-splitting device; the light is shielded when running through the first polarizer; and hence a completely dark state can be achieved. When the LCD panel is in a bright state, light running through the liquid crystal molecules of the LCD panel is rotated by an angle, e.g., 90 degree; the light running through the liquid crystal layer of the liquid crystal light-splitting device is also rotated by the same angle, e.g., 90 degrees; then, the light completely passed through the first polarizer, and hence a bright display can be achieved.

As seen from above, in the embodiments of the present invention, by arrangement of the liquid crystal light-splitting device and the first polarizer on an upper surface of the LCD panel, when the 3D LCD device displays a 2D image, each second pixel unit of the liquid crystal light-splitting device has a completely consistent operating state with corresponding first pixel unit and rotation angles of the liquid crystal molecules in each second pixel unit is completely consistent with these of the liquid crystal molecules in corresponding first pixel unit. When the LCD panel is in a dark state, the light which cannot be shielded by the upper polarizer of the LCD panel is shielded again by the liquid crystal light-splitting device, and hence a completely dark state can be achieved, and consequently the high contrast of the 3D LCD device can be achieved.

Moreover, when the 3D LCD device displays a 3D image, an electric field is formed by applying voltage to the first electrodes 111 and the second electrodes 121 of the liquid crystal light-splitting device, so that the liquid crystal light-splitting device is made into a grating provided with a plurality of lens units, e.g., a lenticular lens provided with a plurality of convex lens units, or is made into a liquid crystal grating, namely a liquid crystal grating with light-transmitting stripes and light-shielding stripes, and hence the 3D image can be displayed.

It should be noted that the operating mode of the LCD panel and the liquid crystal light-splitting device, provided by the embodiment of the present invention, may be a vertical alignment (VA) mode, a twisted nematic (TN) mode, a fringe field switching (FFS) mode or a in-plane switching (IPS) mode. No limitation will be given in the embodiments of the present invention.

### A Second Embodiment

The second embodiment provides a method for driving the 3D LCD device as mentioned above, which comprises:

When the 3D LCD device is in the 3D operating mode, the liquid crystal light-splitting device is formed into a liquid crystal lens or a liquid crystal grating; and when the 3D LCD device is in the 2D operating mode, the first electrodes and the second electrodes of each second pixel unit of the liquid crystal light-splitting device are applied with a voltage or not applied with a voltage, so that liquid crystal molecules in the second liquid crystal layer of each second pixel unit and liquid crystal molecules in the first liquid crystal layer of corresponding first pixel unit have same inclination angle.

Exemplarily, the first electrodes and the second electrodes of each second pixel unit are respectively applied with voltages respectively being identical with these of a pixel electrode and a common electrode of corresponding first pixel unit or not applied with voltages as the same with the pixel electrode and the common electrode.

Exemplarily, when the liquid crystal light-splitting device is formed into a liquid crystal lens, the TFTs of all the second pixel units are switched on; the first electrodes and the second electrodes of at least one row/column of second pixel units are respectively applied with the same voltages, so that a first voltage difference of not equal to 0 can be formed between the first electrodes and the second electrodes; the first electrodes and the second electrodes of at least one adjacent row/column of second pixel units are respectively applied with the same voltages, so that a second voltage difference of not equal to 0 can be formed between the first electrodes and the second electrodes, wherein the first voltage difference is greater than or less than the second voltage difference, and hence the liquid crystal light-splitting device is formed into a lenticular lens provided with a plurality of lens units.

It should be noted that: when the liquid crystal light-splitting device is made into the liquid crystal lens, the first electrodes and the second electrodes of one row/column or a plurality of continuous rows/columns of second pixel units may be applied with the same voltages respectively, so that the first voltage difference of not equal to 0 can be formed between the first electrodes and the second electrodes; the first electrodes and the second electrodes of one adjacent row/column or a plurality of continuous rows/columns of second pixel units are applied with the same voltages respectively, so that the second voltage difference can be formed between the first electrodes and the second electrodes; and the number of rows/columns of the second pixel units applied with the same voltage may be determined according to an actual condition as long as a left-eye image and a right-eye image can be entered into a left eye and a right eye by light splitting. No limitation will be given in the present invention.

Exemplarily, when the liquid crystal light-splitting device is formed into a liquid crystal grating, the TFTs of at least one row/column of second pixel units are switched on; the first electrodes are applied with the same voltage and the second electrodes are applied with the same voltage in this row/column of second pixel units, so that a voltage difference of not equal to 0 can be formed between the first electrodes and the second electrodes; and the TFTs of at least adjacent one row/column of second pixel units are not switched on.

It should be noted that: when the liquid crystal light-splitting device is formed into the liquid crystal grating, the first electrodes and the second electrodes of one row/column or a plurality of rows/columns of second pixel units may be applied with the same voltages respectively; one row/column or a plurality of adjacent rows/columns of second pixel units are not applied with a voltage; the number of rows/columns of second pixel units applied with voltage or not applied with voltage may be determined according to actual conditions as long as a left-eye image and a right-eye image can be entered into a left eye and a right eye by light splitting. No limitation will be given in the present invention.

It should be noted that the 3D LCD device provided by the embodiment of the present invention may be a liquid crystal display, an electronic paper, a liquid crystal television, a digital photo frame, a mobile phone, a tablet PC or any other product or component with the display function.

The 3D LCD device provided by the embodiment of the present invention can operate in the 2D and 3D display modes, has an improved contrast in the case of the 2D display mode, and can achieve a completely dark display of a 2D image.

The embodiment of the invention being thus described, it will be obvious that the same may be varied in many ways. Such variations are not to be regarded as a departure from the spirit and scope of the invention, and all such modifications as would be obvious to those skilled in the art are intended to be included within the scope of the following claims.

1. A three-dimensional (3D) liquid crystal display (LCD) device, comprising:
an LCD panel, configured to display an image and comprising a plurality of first pixel units;
a liquid crystal light-splitting device, disposed on a light exiting side of the LCD panel and comprising a plurality of second pixel units; and
a first polarizer, disposed on a light exiting side of the liquid crystal light-splitting device,
wherein the second pixel units are in one-to-one correspondence with the first pixel units; in a condition that the 3D LCD device is in a 3D operating mode, the liquid crystal light-splitting device has a light-splitting function; and in a condition that the 3D LCD device is in a 2D operating mode, an operating state of each of the plurality of second pixel units of the liquid crystal light-splitting device is consistent with that of a corresponding first pixel unit.

2. The 3D LCD device according to claim 1, wherein the LCD panel comprises:
a liquid crystal cell, comprising:
an array substrate;
a color filter substrate, cell-assembled with the array substrate; and
a first liquid crystal layer, interposed between the array substrate and the color filter substrate;
an upper polarizer, disposed on a light exiting side of the liquid crystal cell; and
a lower polarizer, disposed on a light incident side of the liquid crystal cell.

3. The 3D LCD device according to claim 2, wherein the liquid crystal light-splitting device comprises:
a first substrate, configured to have the same structure as the array substrate;
a second substrate, cell-assembled with the first substrate; and
a second liquid crystal layer, disposed between the first substrate and the second substrate.

4. The 3D LCD device according to claim 3, wherein the first substrate comprises a plurality of second data lines and a plurality of second gate lines intercrossed with each other; each of the second pixel units is defined by the plurality of second data lines and the plurality of second gate lines intercrossed with each other; and
in each of the second pixel units, the first substrate comprises:
a first base substrate;
a thin film transistor, formed on the first base substrate; and
a first electrode, formed on one side of the first base substrate facing the second liquid crystal layer and electrically connected with a source/drain electrode of the thin film transistor.

5. The 3D LCD device according to claim 4, wherein the second substrate comprises:
a second base substrate; and
a second electrode, formed on one side of the second base substrate facing the second liquid crystal layer.

6. The 3D LCD device according to claim 1, wherein the liquid crystal light-splitting device further comprises:
a first alignment film, formed on one side of the first electrode close to the second liquid crystal layer; and
a second alignment film, formed on one side of the second electrode close to the second liquid crystal layer.

7. The 3D LCD device according to claim 1, wherein the first electrode and the second electrode are made of transparent conductive material.

8. The 3D LCD device according to claim 1, further comprising:
a backlight, disposed on one side of the LCD panel opposite to the liquid crystal light-splitting device.

9. The 3D LCD device according to claim 1, wherein transmission axis directions of the upper polarizer and the lower polarizer are parallel with or perpendicular to each other.

10. The 3D LCD device according to claim 9, wherein a transmission axis direction of the first polarizer is parallel with the transmission axis direction of the upper polarizer in a condition that the transmission axis directions of the upper polarizer and the lower polarizer are parallel with each other.

11. The 3D LCD device according to claim 9, wherein a transmission axis direction of the first polarizer is perpendicular to the transmission axis direction of the upper polarizer in a condition that the transmission axis directions of the upper polarizer and the lower polarizer are perpendicular to each other.

12. The 3D LCD device according to claim 4, wherein both the first base substrate and the second base substrate are made of transparent material.

13. The 3D LCD device according to claim 3, wherein the first substrate comprises a plurality of second data lines and a plurality of second gate lines intercrossed with each other; each of the second pixel units is defined by the plurality of second data lines and the plurality of second gate lines intercrossed with each other; and
in each of the second pixel units, the first substrate comprises:
a first base substrate;
a thin film transistor, formed on the first base substrate;
a plurality of strip-shaped first electrodes, formed in parallel on one side of the first base substrate facing the second liquid crystal layer and electrically connected with a source/drain electrode of the thin film transistor; and
a plurality of strip-shaped second electrodes, formed in the same layer with the first electrodes,
wherein the plurality of strip-shaped second electrodes and the plurality of strip-shaped first electrodes are alternately disposed and parallel with each other.

14. The 3D LCD device according to claim 3, wherein the first substrate comprises a plurality of second data lines and a plurality of second gate lines intercrossed with each other; each of the second pixel units is defined by the plurality of second data lines and the plurality of second gate lines intercrossed with each other; and
in each of the second pixel units, the first substrate comprises:
a first base substrate;
a thin film transistor, formed on the first base substrate;
a plurality of strip-shaped first electrodes, formed in parallel on one side of the first base substrate facing the second liquid crystal layer and electrically connected with a source/drain electrode of the thin film transistor; and
a plane-shaped second electrode, separated from a layer where the plurality of strip-shaped first electrodes are disposed by an insulating layer and more close to the first base substrate.

15. The 3D LCD device according to claim 3, wherein the first substrate comprises a plurality of second data lines and a plurality of second gate lines intercrossed with each other; each of the second pixel units is defined by the plurality of second data lines and the plurality of second gate lines intercrossed with each other; and
in each of the second pixel units, the first substrate comprises:
a first base substrate;
a thin film transistor, formed on the first base substrate;
a plurality of strip-shaped first electrodes, formed in parallel on one side of the first base substrate facing the second liquid crystal layer and electrically connected with a source/drain electrode of the thin film transistor; and
a plurality of strip-shaped second electrodes, separated from a layer where the plurality of strip-shaped first electrodes by an insulating layer,
wherein each of the second electrodes is disposed between every two adjacent first electrodes and more close to the first base substrate.

16. A driving method of the 3D LCD device according to claim 1, comprising:
in a condition that the 3D LCD device is in a 3D operating mode, the liquid crystal light-splitting device is formed into a liquid crystal lens or a liquid crystal grating; and
in a condition that the 3D LCD device is in a 2D operating mode, the first electrode and the second electrode of each of the second pixel units of the liquid crystal light-splitting device are applied with voltage or not applied with voltage, so that liquid crystal molecules in the second liquid crystal layer of each second pixel unit and liquid crystal molecules in the first liquid crystal layer of corresponding first pixel unit have same inclination angle.

17. The driving method of the 3D LCD device according to claim 16, wherein the first electrode and the second electrode of each second pixel unit are respectively applied with voltages respectively being identical with a voltage of a pixel electrode and a voltage of a common electrode of corresponding first pixel unit or not applied with voltage as the same with the pixel electrode and the common electrode.

18. The driving method of the 3D LCD device according to claim 16, wherein in a condition that the liquid crystal light-splitting device is formed into the liquid crystal lens, the thin film transistors of all the second pixel units are switched on; the first electrodes are applied with the same voltage and the second electrodes are applied with the same voltage in at least one row/column of second pixel units, so that the first voltage difference of not equal to 0 is formed between the first electrode and the second electrode; the first electrodes are applied with the same voltage and the second electrodes are applied with the same voltage in at least one adjacent row/column of second pixel units, so that the second voltage difference of not equal to 0 is formed between the first electrodes and the second electrodes; the first voltage difference is greater than or less than the second voltage difference; and the liquid crystal light-splitting device is formed into a lenticular lens provided with a plurality of lens units.

19. The driving method of the 3D LCD device according to claim 16, wherein in a condition that the liquid crystal light-splitting device is a liquid crystal grating, each thin film transistor of at least one row/column of second pixel units is switched on; the first electrodes and the second electrodes of the at least one row/column of second pixel units are applied with the same voltage respectively, so that a voltage difference of not equal to 0 is formed between the first electrodes and the second electrodes; and each thin film transistor of at least one adjacent row/column of second pixel units is not switched on.
